(19) United States
(12) Patent Application Publication
(10) Pub. No.: US 2026/0117571 A1
(43) Pub. Date: Apr. 30, 2026

(54) LOCKOUT HANGER SYSTEM

(71) Applicant: THE BOEING COMPANY, Arlington, VA (US)

(72) Inventor: Jason Parsons, Summerville, SC (US)

(21) Appl. No.: 19/264,205

(22) Filed: Jul. 9, 2025

Related U.S. Application Data
(60) Provisional application No. 63/711,785, filed on Oct. 25, 2024.

(51) Int. Cl. E05D 5/10; B64D 29/06; E05D 5/02

(52) U.S. Cl. CPC E05D 5/10; B64D 29/06; E05D 5/0223; E05D 2005/102

(57) ABSTRACT

A system includes a hinge-arm with a clevis end and a pin non-rotatably coupled to a first arm of the clevis end. The pin has a first portion with an outer diameter and a reduced width midsection. A mounting bracket, configurable to couple to a device, receives the pin to enable rotation of a cover coupled to the hinge-arm. The mounting bracket comprises a slot for the reduced width midsection and a joint portion with a diameter corresponding to the pin's outer diameter. The pin is removable when the hinge-arm is rotated to a particular angle range, allowing the reduced width midsection to enter the slot. At angles outside this range, the pin is retained by interference between its outer diameter and the joint portion. This system enables secure attachment and easy removal of access panels in various equipment.

### CROSS-REFERENCE TO RELATED APPLICATIONS

The present application claims the benefit of U.S. Provisional Patent Application No. 63/711,785 entitled “Lockout Hanger System,” filed Oct. 25, 2024, which is expressly incorporated herein by reference in its entirety.

### GOVERNMENT INTEREST STATEMENT

This invention was made with government support under FA8628-19-D-1100-FA8107-21-F-0008 awarded by the Department of Defense. The government has certain rights in the invention.

### FIELD OF THE DISCLOSURE

The present disclosure is generally related to rotational engagement and disengagement of a hinge-arm from a mounting bracket.

### BACKGROUND

In various industries involving large machinery, vehicles, and equipment, maintenance of internal components often requires access to areas enclosed by protective panels or doors. These access points are typically designed to open and close for routine maintenance procedures. The installation and removal of these access panels, especially in areas with limited accessibility, has long been a challenge in equipment maintenance across multiple sectors.

Existing solutions for rotationally connecting covers to corresponding structure include quick-release pins with lug and gooseneck hinges, hook and pin hangers not common to the hinge line, and lever arm and slotted pin systems. However, these existing solutions may present significant ergonomic challenges for maintenance personnel, particularly when the hinge lines are located in hard-to-reach areas. The existing solutions frequently require intricate maneuvers, specialized tools, or direct access to the hinge line for installation and removal of covers.

These limitations in existing solutions can lead to increased maintenance time, potential safety risks for personnel, and higher operational costs for equipment operators. Additionally, some existing solutions do not provide secure engagement when the cover is in an open position, which raises concerns about stability and safety during maintenance procedures.

There is a need for an improved lockout hanger system for rotatable covers that addresses these limitations, particularly for use in locations with restricted access. Such lockout hanger systems simplify installation and removal processes, enhance safety, and improve overall maintenance efficiency without compromising the structural integrity of equipment.

### SUMMARY

In a particular implementation, a system includes a hinge-arm comprising a clevis end and a pin non-rotatably coupled to a first arm of the clevis end. The pin includes a first portion between the first arm and a second arm of the clevis end, where an outer surface of the first portion includes a first cylindrical arc, a second cylindrical arc, and a reduced width midsection between the first cylindrical arc and the second cylindrical arc. A mounting bracket is configured to couple to a device. The mounting bracket is configured to receive the pin to enable a cover coupled to the hinge-arm to be rotatable positioned relative to the device. The mounting bracket comprises a slot to allow passage of the reduced width midsection of the pin and a joint portion complementary to the first cylindrical arc and the second cylindrical arc of the pin to enable rotation of the pin positioned in the joint portion relative to the mounting bracket. The pin is removable from the joint portion when the hinge-arm is rotated relative to the mounting bracket to a particular angle range that enables entry of the reduced width midsection in the slot. The pin is retained in the joint portion at angles less than the particular angle range, greater than the particular angle range, or both, by interference of the first portion with the joint portion to prevent entry of the first portion in the slot.

In another particular implementation, a system includes a hinge-arm having a clevis end with a first arm and a second arm. The system includes a pin non-rotatably coupled to the first arm of the clevis end. The pin includes a first portion between the first arm and the second arm of the clevis end. An outer surface of the first portion includes a first cylindrical arc, a second cylindrical arc, and a reduced width midsection between the first cylindrical arc and the second cylindrical arc. A mounting bracket is configured for attachment to a structure. The mounting bracket includes a joint portion having a diameter complementary to the first cylindrical arc and the second cylindrical arc of the pin to enable rotation of the pin positioned in the joint portion relative to the mounting bracket. The mounting bracket includes a slot extending from the joint portion. The slot is sized to allow passage of the reduced width midsection of the pin. The pin is removable from the joint portion when the hinge-arm is rotated relative to the mounting bracket to a particular angle range that enables entry of the reduced width midsection in the slot. The pin is retained in the joint portion at angles less than the particular angle range, greater than the particular angle range, or both, by interference of the first portion with the joint portion to prevent entry of the first portion in the slot.

In another particular implementation, a method for removing a cover from a structure includes rotating the cover to a position at a first angle, where the first angle is in a particular angle range that enables entry of a reduced width midsection of a first portion of a pin in a slot of a mounting bracket coupled to the structure. The first portion is positioned in a joint portion of the mounting bracket. An outer surface of the first portion includes a first cylindrical arc, a second cylindrical arc, and the reduced width midsection between the first cylindrical arc and the second cylindrical arc. The joint portion is complementary to the first cylindrical arc and the second cylindrical arc of the pin to enable rotation of the pin positioned in the joint portion. The first cylindrical surface and the second cylindrical surface interfere with the joint portion to prevent entry of the reduced width midsection in the slot when the cover is not positioned at an angle in the particular angle range. The method also includes applying a force to the cover to move the pin from the joint portion through the slot and out of the mounting bracket to detach the cover from the structure.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a top view representation of an aircraft showing locations for lockout hanger systems and a particular implementation of a lockout hanger system.

FIG. 2 is a perspective view representation of a pin that can be used in the lockout hanger system of FIG. 1.

FIG. 3 illustrates a perspective view representation of the pin and a portion of the hinge-arm of the lockout hanger system of FIG. 1.

FIG. 4 illustrates a cross-sectional representation, taken substantially along the cutting plane 4-4 of FIG. 3, of the pin and a portion of the hinge-arm of the lockout hanger system of FIG. 1.

FIG. 5 illustrates a perspective representation of a lockout hanger system with a cut-away portion of a hanger-arm to emphasize positioning of a pin of the lockout hanger system in a corresponding mounting bracket.

FIG. 6 is perspective view representation of a pin that can be used in the lockout hanger system.

FIG. 7 illustrates an example of a sequence for removing a hinge-arm and pin of a lockout hanger system from a mounting bracket.

FIG. 8 is a front view representation of an implementation of a lockout hanger system.

FIG. 9 is a flow chart of a method of use of a lockout hanger system.

FIG. 10 is a flowchart illustrating an example of a life cycle of an aircraft that includes a lockout hanger system of FIG. 1.

FIG. 11 is a block diagram illustrating aspects of an illustrative aircraft that includes a lockout hanger system of FIG. 1.

### DETAILED DESCRIPTION

Aspects disclosed herein present systems, apparatus, and methods for securing and releasing covers coupled to structure by lockout hanger systems in various applications, particularly in environments with limited accessibility. These aspects address the challenge of ergonomically difficult installations and removal of a cover (e.g., a panel, door, or other type of cover) by providing a lockout hanger system that enables easy attachment and detachment in a specific angle range, while ensuring secure fastening during normal use.

The cover is coupled to structure of a device (e.g., an engine support for an engine) by one or more lockout hanger systems. For some implementations that use multiple lockout hanger systems coupled to the cover, a hinge line for rotation of the cover is a common center line of pins of the lockout hanger systems. Each lockout hanger system for the cover includes a hinge-arm, which may be gooseneck-shaped arm, coupled to the cover, a pin non-rotationally coupled to the hinge-arm, and a corresponding mounting bracket that receives the pin. Each hinge-arm can include a clevis end. The pin is non-rotatably coupled to the clevis end. The pin includes a first portion including a first cylindrical arc, a second cylindrical arc, and a reduced width midsection between the first cylindrical arc and the second cylindrical arc (e.g., the first portion is a two-flat shaft or a D-shaped shaft). The mounting bracket, which is typically affixed to a supporting structure, includes a hook with a slot and a joint portion configured to receive the first portion of the pin. When the cover is rotated to an angle in a particular angle range, for example 15 degrees from a closed position, the reduced width portion of the pin aligns with the slot in the mounting bracket and application of a radial force relative to a center of the joint portion enables movement of the pin in the slot towards the joint portion during insertion, or away from the joint portion during removal. The alignment facilitates insertion or removal of the pin relative to the mounting bracket and allows for quick and ergonomic installation or detachment of the cover. When the pin is positioned in the joint portion of the mounting bracket, the pin is retained in the joint portion at angles less than the particular angle range, greater than the particular angle range, or both, by interference of the first portion with the joint portion to prevent entry of the first portion in the slot. In other implementations, the pin is non-rotationally coupled to the mounting bracket, and the hinge-arm includes the hook with the slot and the joint portion configured to accommodate the pin.

By using the techniques and systems described herein for a lockout hanger system, several advantages are realized over existing solutions. The lockout hanger system enhances accessibility by eliminating a need for direct access to a hinge line of the lockout hanger system, which simplifies maintenance and operation in confined spaces. The lockout hanger system improves ergonomics by reducing physical strain on operators during cover manipulations. Safety is provided through the self-locking feature at angles other than angles in a particular angle range (e.g., a removal angle range). In some implementations, the cover remains coupled to the mounting bracket when no force is applied to the cover to remove the pin from the mounting bracket. In other implementations, the weight of the cover applies the force that removes the cover from the mounting bracket. The particular angle range may be narrow (e.g., plus or minus 0.5 degrees, 1 degree, 1.5 degrees, or some other angle relative to a reference plane) to inhibit accidental detachment during operation or transit. The system streamlines maintenance by eliminating the need for additional tools or complex procedures during installation or removal, thereby potentially reducing downtime and associated costs.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

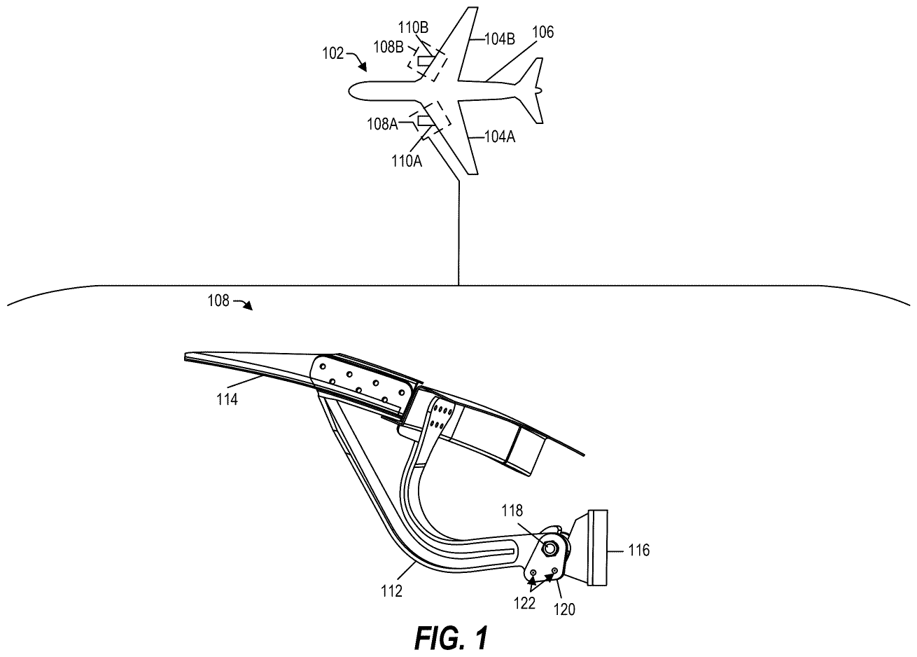

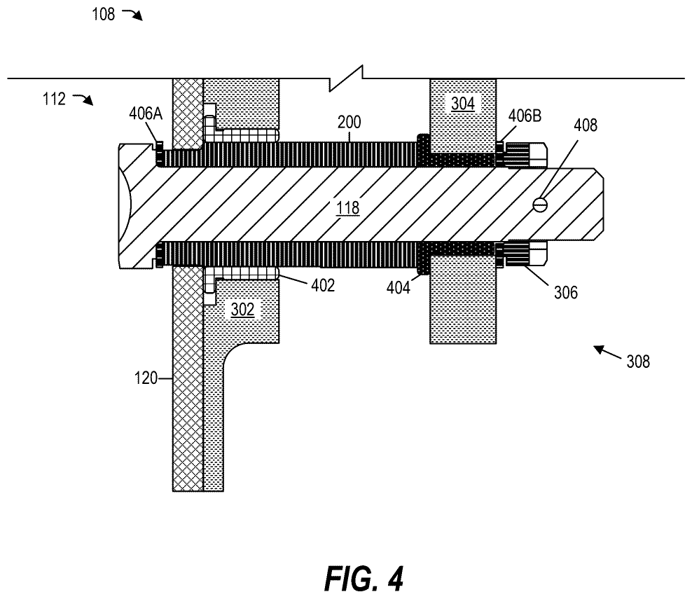

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple lockout hanger systems 108 are illustrated and associated with the reference numbers 108A and 108B. When referring to a particular one of these lockout hanger systems 108, such as the lockout hanger system 108A, the distinguishing letter “A” is used. However, when referring to any arbitrary one of these lockout hanger systems, the reference number 108 is used without a distinguishing letter. In another example, referring to FIG. 4, multiple washers 406 are illustrated and associated with reference numbers 406A and 406B. When referring to a particular one of these washers, such as the washer 406A, the distinguishing letter “A” is used. However, when referring to any arbitrary one of these washers, the reference number 406 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. For case of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1 depicts an example of an aircraft 102 that has a wings 104A, 104B coupled to a fuselage 106. An engine 110 is coupled to each of the wings 104, via an engine pylon or strut, and the engine 110 is enclosed inside of a nacelle. Each engine 110 can be accessed through the nacelle with one or more removeable covers 114 (e.g., engine cowl(s)). Each cover 114 may be coupled to the engine pylon by one or more lockout hanger systems 108.

In some implementations, positions of the wings 104 limit how far the covers 114 can be opened, and a worker may not be able to access portions of the particular engine 110 when a particular cover 114 for a particular engine 110 is fully opened. Removing the particular cover 114 may allow access to one or more additional portions of the engine 110, provide ample working room, or both. The lockout hanger system(s) 108 facilitate removal of the covers 114 and attachment of the covers 114 to the corresponding engines 110.

In the implementation depicted in FIG. 1, the lockout hanger systems 108 are used in conjunction with the aircraft 102. It should be noted that one or more lockout hanger systems 108 can be used in conjunctions with other types of vehicles (e.g., automobiles, sea vessels, helicopters, trains, etc.), machinery, and equipment (e.g., cabinets, barbeque grills, etc.), and combinations thereof.

The lockout hanger system 108 includes a hinge-arm 112, a mounting bracket 116, and a pin. In some implementations, the pin is non-rotatably coupled to the mounting bracket 116 and a first portion of the pin is positioned in a joint portion of the mounting bracket 116 when the lockout hanger system 108 is coupled together. The pin rotates with the hinge-arm 112 about the center line of the pin when the pin is positioned in a joint portion of the mounting bracket 116 and the hinge-arm is rotated. In other implementations, the pin is non-rotatably coupled to the mounting bracket 116, and the first portion of the pin is positioned in a joint portion of the hinge-arm 112 when the lockout hanger system 108 is coupled together. The hinge-arm 112 rotates about the center line of the pin when the pin is positioned in the joint portion of the hinge-arm 112.

The hinge-arm 112 is coupled to the cover 114. The hinge-arm 112 enables rotational movement of the cover 114 relative to the mounting bracket 116. The mounting bracket 116 attaches to a structure of the aircraft 102 (e.g., an engine strut). As will be described in further detail below, the pin of the lockout hanger system 108 cooperates with the hinge-arm 112 and mounting bracket 116 to secure and release the cover 114.

In some implementations, the hinge-arm 112 is a gooseneck hinge-arm having a clevis end. The clevis end has a first arm and a second arm. The hinge-arm 112 allows for efficient transfer of loads while providing necessary clearance for the cover 114 to open and close smoothly. In some implementations, the hinge-arm 112 is formed of high-strength aerospace-grade materials such as titanium alloys or heat-treated steel to withstand an operational environment produced by an engine 110 inside of the cover 114 and the ambient environment outside of the cover 114. In other implementations, the hinge-arm is formed of carbon steel, aluminum alloy, or other alloys, polymers, or combinations thereof, suitable for particular environment(s) associated with the lockout hanger system 108.

The mounting bracket 116 is configured to receive the pin to enable the cover 114 to be rotatably positioned relative to the aircraft structure. The mounting bracket 116 is configured to include a joint portion and a slot, the geometry of which facilitate a locking and unlocking mechanism of the lockout hanger system 108. In some implementations, the mounting bracket 116 is coupled by fasteners to the aircraft structure. In alternative implementations, the aircraft structure includes an integrated mounting bracket 116.

A bolt 118 is configured to extend through an opening in the pin with the reduced midsection and the arms of the clevis end of the hinge-arm 112. The bolt 118 strengthens the pin and secures the pin to the hinge-arm 112. A head of the bolt and a fastener system (e.g., a hole through a shaft of the bolt, a cotter pin positioned in the hole and in grooves of a nut coupled to the bolt) couple the bolt to the arms of the clevis end.

The lockout hanger system 108 can also include a pin lock out plate 120. The pin lock out plate 120 includes a first opening sized to receive the pin and prevent rotation of the pin relative to the pin lock out plate 120 and the arms of the clevis end. In an implementation, the pin lock out plate 120 is fastened to the first arm of the clevis end by one or more fasteners 122 (e.g., screws). In other implementations, the pin lock out plate 120 is welded or otherwise attached to the first arm.

The cover 114 is secured to the aircraft structure when the pin is retained in the joint portion of the mounting bracket 116. The cover 114 is removable when the cover 114 is rotated to an angle within a particular angle range (e.g., a particular angle plus or minus 0.5 degrees, 1 degree, 1.5 degrees, or some other number of degrees) and a force is applied to the cover 114 to transition a reduced width midsection of a first portion of the pin from the joint portion of the mounting bracket 116 to the slot of the mounting bracket. The angle is less than a maximum angle of rotation of the cover 114. For example, the maximum angle of rotation of the cover 114 of an engine 110 is 35 degrees to prevent the cover 114 from contacting the wing 104 or other structure, a cover support system (e.g., a rod that is removably coupled to the cover and engine support structure to hold the cover in an open position) allows the cover 114 to remain open at a particular angle (e.g., 25 degrees) to allow worker access to a first portion of the engine 110, and the angle range that allows the reduced width midsection of the pin to transition from the joint portion to the slot is substantially 30 degrees (e.g., 30 degrees plus or minus 1 degree) so that the cover 114 is removable from the engine 110 to allow worker access to additional portions of the engine 110. Indicia on the cover 114, in user manuals, other locations, or combinations thereof, provides an indication of a particular angle in the angle range or other indication of the angle range.

While the lockout hanger system 108 is shown here in the context of an aircraft engine, it should be understood that the lockout hanger system 108 is configurable for use in various other applications. For example, similar systems for use in access panels for other types of vehicles, machinery, appliances, architectural applications, etc., where secure but removable covers are required.

In some implementations, the lockout hanger system 108 is configured to incorporate sensors to detect the position of the cover 114 and the engagement status of the pin with the mounting bracket 116. This information is relayed to a central computer system of the aircraft 102, which provides real-time status updates to the flight crew and maintenance personnel.

By using the techniques and systems described herein, the lockout hanger system 108 has the technical advantages of providing a secure and efficient mechanism for attaching and detaching the cover 114 in locations that are ergonomically challenging to access. The design of the pin, working in conjunction with the joint portion and slot of the mounting bracket 116, allows for a robust locking mechanism that can be disengaged within a particular angle range. This feature reduces the risk of accidental detachment of the cover 114 when the cover 114 is not locked in a closed position.

Furthermore, the lockout hanger system 108 offers improved maintenance efficiency. The lockout hanger system 108 allows for quick and easy removal of the cover 114 when the cover 114 is rotated to a position within the particular angle range between a closed position and a maximum open position. This design eliminates the need for complex tools or procedures, potentially reducing maintenance time and associated costs.

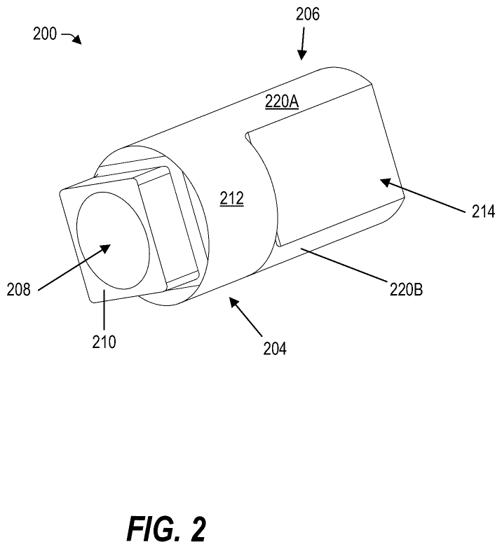

FIG. 2 illustrates a perspective view of a pin 200 of the lockout hanger system 108 of FIG. 1. The pin 200 includes a first portion 206, a second portion 204, and an opening 208 through the pin 200.

The first portion 206 has an outer surface that includes a first cylindrical arc 220A, a second cylindrical arc 220B, and a reduced width midsection 214 between the first cylindrical arc 220A and the second cylindrical arc 220B. The configuration of the reduced width midsection 214 in relation to the cylindrical arcs 220A, 220B enables the hinge-arm 112 of FIG. 1 to lock to, or unlock from, the mounting bracket 116. This configuration allows the reduced width midsection 214 to pass into and through a slot in the mounting bracket when the pin 200 is rotated to a specific angle range, while preventing passage into the slot at other angles due to interference between the cylindrical arcs 220A, 220B positioned in the joint portion of the mounting bracket with the joint portion. The interaction between the reduced width midsection 214, the cylindrical arcs 220A, 220B, and the mounting bracket (e.g., the mounting bracket 116 as described in FIG. 1) creates a secure locking mechanism when the pin 200 is in certain rotational positions, while allowing for easy removal of the pin 200 when the pin 200 is rotated to an angle in a particular angle range.

In some implementations, the second portion 204 includes an extension portion 212 and a head 210 configured to interact with a pin lock out plate, described further below, to prevent rotation of the pin 200 relative to a clevis end of the hinge-arm. In FIG. 2, the head 210 has a square shape, but it can be configured in various other shapes. In some implementations, the head 210 and an opening 208 for the head 210 in the pin lock out plate include features (e.g., a key and a keyway) that allows for only one orientation of the pin 200 relative to the pin lock out plate, instead of the two orientations of the pin 200 that are possible with the square shape head 210.

All or some of the extension portion 212 is positioned in an opening through the first arm of the clevis end of the hinge-arm. In some implementations, the extension portion 212 and the opening through the first arm of the clevis head include features (e.g., a key and a keyway) that allows for only one orientation of the pin 200 relative to the first arm of the clevis end and prevents rotation of the pin relative to the first arm.

The pin 200 is made of a metal (e.g., steel, or other alloy) able to withstand forces applied by the hinge-arm and mounting plate to the pin 200, the environment beneath the cover, corrosion, vibration, other factors, or combinations thereof. In some implementations, the pin 200 is formed from a piece of pipe or rod stock.

The opening 208 extends through the pin 200. The opening 208 is configured to receive a bolt (e.g., the bolt 118 of FIG. 1) that secures the pin 200 to the hinge-arm and strengthens the pin 200. The alloy selected for the pin 200 may be selected for wear control and for limiting wear to one part or another of a joint formed by the pin 200 and the mounting bracket without a cost associated with a monolithic pin made of the alloy. In other implementations, a monolithic pin is used instead of a pin 200 with the opening 208 and bolt combination. For example, the monolithic pin is a customized, stepped shoulder bolt.

By utilizing the pin 200, the one or more lockout hanger systems can provide secure attachment of the cover to a structure while allowing for easy removal when the cover is positioned at an angle in a particular angle range. This configuration can enhance maintenance efficiency, improve safety, and offer versatility across various industries and applications.

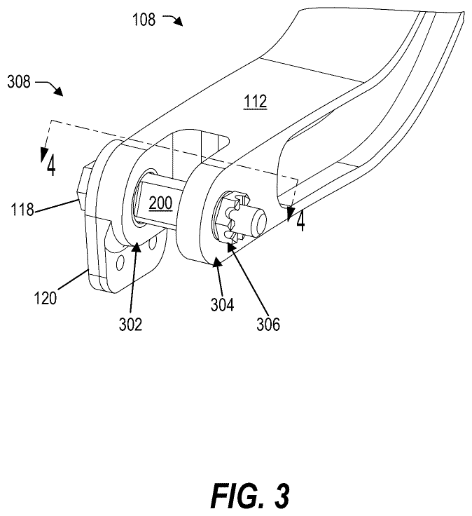

FIG. 3 illustrates a perspective view of the pin 200 and the hinge-arm 112 of the lockout hanger system 108 of FIG. 1. The pin 200 allows for rotational movement of the hinge-arm 112 relative to the mounting bracket of the lockout hanger system 108. A center line of the pin 200 is a hinge line for the lockout hanger system 108. In FIG. 2, the hinge-arm 112 includes a clevis end 308. The clevis end 308 includes a first arm 302 and a second arm 304. The pin 200 is non-rotatably coupled to the first arm 302, the second arm 304, or both.

During assembly of the hinge-arm 112, the pin 200 is positioned in the clevis end 308 through an opening of the first arm 302 and the pin lock out plate 120 is coupled to the head of the pin 200 and the first arm 302 to fix the position of the pin 200 so that the pin 200 is non-rotatable relative to the arms 302, 304 of the clevis end 308. The head of the pin 200 is positioned in a correspondingly shaped opening in the pin lock out plate 120 that prevents rotation of the pin 200 relative to the pin lock out plate 120. The pin lock out plate 120 is coupled to the first arm 302 by fasteners (e.g., screws) or one or more welds. When the pin 200 is inserted into the opening in the first arm 302, the end of the pin 200 opposite to the head of the pin 200 abuts against the second arm 304, or a flange positioned in an opening through the second arm 304. In other implementations, a portion of the pin 200 extends into, or through, an opening in the second arm 304 sized to receive the end of the pin 200.

Also, during assembly of the hinge-arm 112, the bolt 118 is positioned through the opening in the pin 200 and secured with a nut 306 to strengthen the pin 200 and secure the pin 200 to the pin lock out plate 120 and the clevis end 308. In some implementations, the bolt 118 is secured in place by a nut 306 with grooves (e.g., a castellated nut) and a cotter pin (shown in FIG. 4). The nut 306 with grooves is threaded on the bolt 118 so that a transverse opening through the bolt 118 aligns with a pair of the grooves in the nut 306. Arms of the cotter pin are positioned through a transverse opening in the bolt 118, positioned in the pair of grooves of the nut 306, and the arms of the cotter pin are bent to prevent removal of the cotter pin and a change in position of the nut 306 relative to a head of the bolt 118.

The materials used for the components of the lockout hanger system 108 is configured to withstand environmental conditions of use for the lockout hanger systems. For instance, the hinge-arm 112, the pin 200, and the bolt 118 are made from corrosion-resistant alloys for applications in marine environments. Alternatively, or in addition, for high-temperature applications, these components made from heat-resistant materials.

FIG. 4 illustrates a cross-sectional representation of the clevis end 308 of the hinge-arm 112 depicted in FIG. 3. The hinge-arm 112 and the pin 200 are components of the lockout hanger system 108. The pin 200 is configured to extend through an opening in the first arm 302.

During assembly of the hinge-arm 112 depicted in FIG. 4, openings with different diameters and common center axis are formed through the first arm 302 and the second arm of the hinge-arm 112. Flange 402 is positioned in the opening through the first arm 302 and flange 404 is positioned in the opening through the second arm 304. In some implementations, the flange 402, the flange 404, or both, are bushing flanges. The pin 200 is positioned in the clevis end 308 through the opening through the first arm 302 so that an end of the pin 200 opposite to a head of the pin 200 contacts the flange 404. The pin lock out plate 120 is then coupled to the head of the pin 200 and the first arm 302 to non-rotatably couple the pin 200 to the first arm 302 of the hinge-arm 112. The head of the pin 200 is positioned in a correspondingly shaped opening in the pin lock out plate 120 that prevents rotation of the pin 200 relative to the pin lock out plate 120 and the first arm 302. The pin lock out plate 120 is coupled to the first arm 302 by fasteners (e.g., screws, one or more welds, etc.).

A washer 406A is placed against a head of the bolt 118 and the bolt is positioned is positioned in the opening through the pin 200. A washer 406B is placed on the end of the bolt 118 that extends past the second arm 304. The nut 306 is threaded to the bolt 118 and tightened against the washer 406B until the transverse opening through the bolt 118 aligns with a pair of grooves in the nut 306. A cotter pin 408 is positioned in the grooves and through the transverse opening, and arms of the cotter pin 408 are bent to inhibit removal of the cotter pin 408 and movement of the nut 306 relative to the bolt 118. The flange 404 is a clamped flange that is clamped between the pin 200 and the washer 406B. The flange 402 is an unclamped flange held in position by the pin lock out plate 120 and the first arm 302.

When the pin 200 is retained in the joint portion of the mounting bracket and the cover is at an angle other than an angle in the particular angle range that enables the reduced width midsection of the pin 200 to enter the slot of the mounting bracket, the hinge-arm 112 is securely coupled to the mounting bracket to form the lockout hanger system 108. When the cover is rotated to a closed position, a releasable locking mechanism (e.g., a spring latch) secures the cover in the closed position. The releasably locking mechanism is released to allow the cover to be rotated to a particular position. A releasable system (e.g., a rod coupled to the cover and structure or other system) enables the cover to remain open at the particular position. In some implementations, the cover does not include a releasable locking mechanism that secures the cover in the closed position and the cover is rotatable to and from the closed position.

The materials used for the components of the lockout hanger system 108 are configured to withstand various environmental conditions. For example, the hinge-arm 112, the pin 200, and the bolt 118 made from corrosion-resistant alloys for applications in marine environments. Alternatively, or in addition, for high-temperature applications, these components are configured to be made from heat-resistant materials. This ensures the lockout hanger system's 108 reliability across a range of operational conditions.

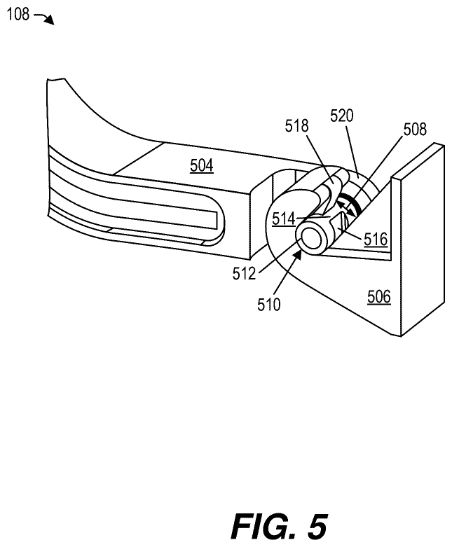

FIG. 5 illustrates a representation of a portion of a lockout hanger system 108 that shows a cut-away portion of a hinge-arm 504 to emphasize positioning of a pin 512 of the lockout hanger system in a joint portion 510 of a corresponding mounting bracket 506. The pin 512 is non-rotatably coupled to the hinge-arm 504. The mounting bracket 506 includes a slot 508 and the joint portion 510. A first portion of the pin 512 includes an outer surface with cylindrical arcs 514 separated by a reduced width midsection 516.

The hinge-arm 504 can be the hinge-arm 112, as described in FIG. 1. The hinge-arm 504 includes a first arm 520. The hinge-arm 504 enables rotational movement of a cover (e.g., the cover 114 as described in FIG. 1) coupled to the hinge-arm 504 relative to the mounting bracket 506.

The mounting bracket 506 can be the mounting bracket 116, as described in FIG. 1. The mounting bracket 506 is configured for attachment to, or is integral component of, a structure, such as an engine strut or pylon of an aircraft.

The joint portion 510 has a cylindrical shape that corresponds to the cylindrical arc portions 514 of the pin 512. The shape of the joint portion 510 enables rotation of the first portion of the pin 512 in the joint portion 510. The shape of the joint portion 510 also prevents separation of the pin 512 from the joint portion 510 when the reduced width midsection 516 of the pin 512 is not aligned with the slot 508 that extends from the joint portion 510 of the mounting bracket 506. When the reduced width midsection 516 of the pin 512 is aligned with the slot 508, application of a radial force to the pin 512 in the direction of the slot 508 allows the pin to enter the slot 508 and allows the pin 512 and hinge-arm 504 to be separated from the mounting bracket 506.

The slot 508 is sized to allow passage of the reduced width midsection 516 of the pin 512 but is too narrow at the connection to the joint portion to allow entry of the first portion when the reduced width midsection 516 is not aligned with the slot 508. When the reduced width midsection 516 is not aligned with the slot 508, the cylindrical arc portions 514 of the pin 512 interfere with the joint portion 510 of the mounting bracket 506 to prevent passage of the pin 512 into the slot 508. This configuration creates a secure locking mechanism when the pin 512 is in certain rotational positions, while allowing for removal of the pin 512 when it is rotated to an angle in the particular angle range. In some implementations, the slot 508 has an outward tapered profile with a narrow end at the interface with the joint portion 510, a curved profile, or both, to facilitate guidance of the reduced width midsection of the pin 512 during insertion and removal of the pin 512 coupled to the hinge-arm 504.

The pin 512 depicted in FIG. 5 includes cylindrical extension sections on each side of the first portion with the reduced width midsection 516. This configuration enables a limited portion of the width of the mounting bracket 506 defined by a protrusion 518 in a hook portion of the mounting bracket 506 to be configured to define the slot 508 instead of having the first portion of the pin 512 conform to the width of the mounting bracket 506. In some implementations, the mounting bracket 506 includes more than one protrusion 518 and the pin 512 includes corresponding first portions with reduced width midsections 516 to interact with the protrusions 518.

The pin 512 is removable from the joint portion 510 only when the hinge-arm 504 is rotated relative to the mounting bracket 506 to an angle within the particular angle range. This particular angle range enables entry of the reduced width midsection of the pin 512 into the slot 508. The lockout hanger system 108 is configured such that the pin 512 is retained in the joint portion 510 at angles less than the particular angle range, greater than the particular angle range, or both. This retention occurs by interference of cylindrical arcs 514 of the pin with the joint portion 510, which prevents entry of the reduced width midsection into the slot 508.

The particular angle range is a particular angle plus or minus a limited number of degrees. The particular angle may be an angle within a range of rotation of the hinge-arm 504 relative to the mounting bracket 506. For example, the particular angle may be 30 degrees, 35 degrees, 40 degrees, 45 degrees, or some other angle relative to a closed position of the cover. The limited number of degrees deters unwanted separation of the hinge-arm 504 from the mounting bracket 506 during normal operation and maintenance activities. The limited number of degrees may be 0.5 degrees, 1 degree, 1.5 degrees, 2 degrees, or some other angle.

The lockout hanger system 108 includes a pin lock out plate (not shown in FIG. 5) as described in FIGS. 1 and 3 or other connection (e.g., one or more welds) that non-rotatably couples the pin 512 to the hinge-arm 504. The pin 512 is non-rotatably coupled to one or both arms of the hinge-arm 504.

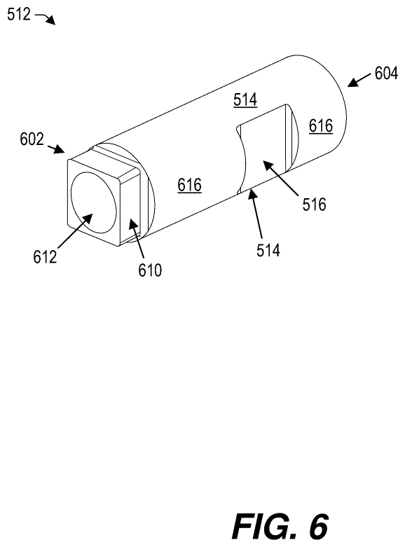

FIG. 6 is a perspective view representation of the pin 512 that can be used in the lockout hanger system of FIG. 5. The pin 512 includes a first end 602, a second end 604, the cylindrical arcs 514, and a reduced width midsection 516 between the first end 602 and the second end 604. In some implementations, the reduced width midsection 516 is formed as a single flat to make a D shaped shaft portion or is formed as two flats to make a double flat shaft portion. In some implementations, a surface of the reduced width midsection 516 has a concave contour.

The first end 602 and the second end 604 of the pin 512 each include extension portions 616. The extension portions are sized so that the cylindrical arc portions 514 and the reduced width midsection 516 are aligned with a corresponding protrusion on a hook of a mounting bracket (e.g., mounting bracket 506 of FIG. 5) that defines the slot and joint portion of the mounting bracket when the pin is non-rotatably coupled to the hinge-arm of the lockout hanger system. In some implementations, the mounting bracket includes two or more protrusions that define two or more slot and joint portions. The pin 512 for such mounting brackets includes cylindrical arc portions 514 and reduced width midsections 516 corresponding to each protrusion of the mounting bracket. The extensions 616 depicted in FIG. 6 are cylindrical portions of the pin 512. In other implementations, the extension portions 616 have a different shape, and the individual extension portions on the same pin 512 can have different shapes.

The first end 602 also includes a head 610 with a substantially square cross section. This square cross section engages a corresponding square-shaped opening in a pin lock out plate to prevent rotation of the pin 512 relative to the hinge-arm when the pin is coupled to the arms of the hinge-arm. In some implementations, the head 610 has another shape (e.g., hexagonal). In some implementations, the pin 512 and the pin lock out plate include features (e.g., a key and a keyway) that establish a single orientation of the pin 512 relative to the hinge-arm.

The pin 512 includes a through opening 612 for a bolt (e.g., the bolt 118 as described in FIGS. 1 and 4) that secures the pin 512 to arms of the hinge-arm and strengthen the pin 512. The bolt is positioned in the opening 612 and secured in place with washers, a nut, a cotter pin, or combinations thereof.

In some implementations, the length of the pin 512 is sized so that the second end 604 abuts against an arm of a clevis end of the hinge-arm or a flange positioned in an opening through the arm for the bolt positioned in the opening 612. In other implementations, the second end 604 of the pin extends partially into or through the opening in the arm.

The pin 512 may be configured with different length ratios between the first end 602, reduced width midsection 516, and second end 604 to meet specific application requirements, such as the thickness of components to be fastened or load support needs.

The pin 512 is typically made from high-strength materials such as titanium alloys or heat-treated corrosion resistant steel to withstand operational stresses. In some implementations, the pin 512 is configured to be the primary wear component of the joint of the lockout hanger system 108 and is replaced periodically or when wear is detected. For high-load applications, high-strength steels or superalloys may be employed. In other implementations, copper nickel tin alloys may be employed.

In some implementations, the pin 512 has a corrosion-resistant coating to enhance durability. Other surface treatments may include dry film lubrication for reduced friction during insertion and removal, or hardened surfaces for wear resistance.

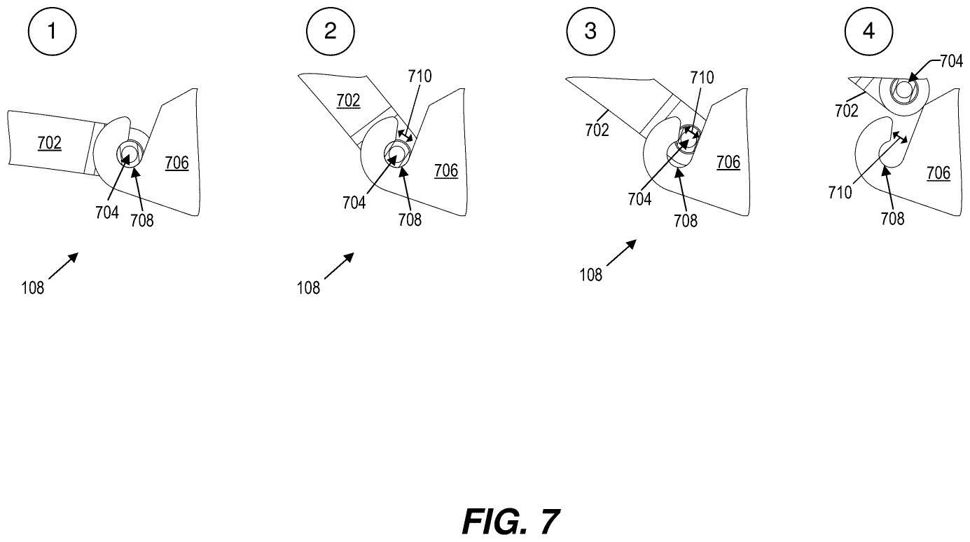

FIG. 7 illustrates an exemplary sequence of separating a hinge-arm 702 and pin 704 of a lockout hanger system 108 from a mounting bracket 706 of the lockout hanger system 108. The lockout hanger system 108, the hinge-arm 702, the pin 704, and the mounting bracket 706 correspond to any of the lockout hanger systems, hinge-arms, pins, and mounting brackets described in FIGS. 1-6.

It should be noted that the sequence of FIG. 7 may combine one or more stages in order to simplify and/or clarify the sequence for separating the hinge-arm 702 and pin 704 from the mounting bracket 706. In the following description, reference is made to various illustrative Stages of the sequence, which are numbered (using circled numbers) in FIG. 7. In some implementations, the order of the Stages may be changed or modified. In some implementations, one or more of the Stages may be replaced or substituted without departing from the scope of the disclosure. In FIG. 7, cut-away views of the hinge-arm 702 and the pin 704 are shown in the illustrative Stages to show the interaction of the pin 704 with the mounting bracket 706, which would otherwise be visibly blocked by a second arm of a clevis end of the hinge-arm 702.

Stage 1 of FIG. 7 illustrates an initial state of the lockout hanger system 108 with the pin 704 positioned in the joint portion 708 of the mounting bracket 706. The pin 704 is non-rotatably coupled to the hinge-arm 702 such that the pin 704 rotates when the hinge-arm 702 rotates. Cylindrical arcs (e.g., cylindrical arcs 220 of FIG. 2) of the pin 704 secure the pin 704 and the hinge-arm 702 to the mounting bracket 706. The position of the hinge-arm 702 may correspond to a closed position of a cover (e.g., cover 114 of FIG. 1) coupled to the hinge-arm 702.

Stage 2 of FIG. 7 depicts the lockout hanger system 108 after rotation of the hinge-arm 702 to a position where the reduced width midsection (e.g., reduced width section 214 of FIG. 2) of the pin 704 aligns with the slot 710 of the mounting bracket 706. A weight of the hinge-arm 702 and the cover (e.g., cover 114) attached to the hinge-arm 702 maintain the pin 704 in the joint portion 708 of the mounting bracket 706. At this position, the pin 704 can be disengaged from the mounting bracket 706 to enable separation of the hinge-arm 702 and pin 704 from the mounting bracket 706, or, in some implementations, the hinge-arm 702 can be further rotated so that the pin 704 is secured in the joint portion 708 of the mounting bracket 706 to inhibit separation of the pin 704 from the joint portion 708 of the mounting bracket 706.

Stage 3 of FIG. 7 depicts the lockout hanger system 108 after application of a force to disengage the pin 704 from the joint portion 708 of the mounting bracket 706 while the mounting bracket 706 is at a particular angle in the angle range that enables transition of the reduced width midsection (e.g., reduced width midsection 214) of the pin 704 into the slot 710 of the mounting bracket 706. A back wall of the slot 710 can facilitate passage of the pin 704 through the slot 710.

Stage 4 of FIG. 7 depicts the hinge-arm 702 and pin 704 after separation from the mounting bracket 706. The sequence is reversible to allow the reattachment of the hinge-arm 702 and pin 704 to the mounting bracket 706 by aligning the reduced width midsection (e.g., reduced width midsection 214) of the pin 704 with the slot 710 at an angle in the angle range, applying a force to insert the pin 704 into the joint portion 708 of the mounting bracket 706 via the slot 710, and rotating the hinge-arm 702 to an angle outside of the angle range to lock the pin 704 in place.

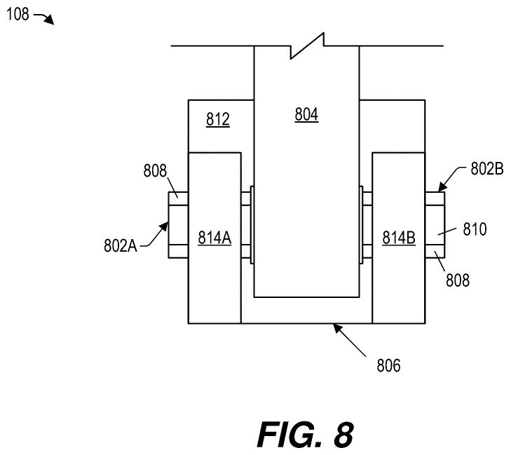

FIG. 8 is a front view representation of pins 802, a portion of a hinge-arm 804, and a mounting bracket 806 of an implementation of a lockout hanger system 108. The pins 802 include cylindrical arcs 808 and reduced width midsections 810. The pins 802 are non-rotatably coupled to each side of the hinge-arm 804 by fasteners (e.g., one or more welds). In some implementations, the pins 802 are a single pin that is pressed fit into an opening through the hinge-arm 804. In other implementations, separate pins 802 are pressed into openings in the hinge-arm 804 or otherwise non-rotatably coupled to each side of the hinge-arm 804. In particular implementations, the opening(s) and the pin(s) 802 include a key and a keyway to establish a desired angle of the reduced width midsection 810 of the pins 802 relative to the hinge-arm 804.

The mounting bracket 806 includes a back wall 812, and hooks 814A, 814B. Each hook 814 includes a joint portion and a slot in communication with the joint portion between an end of the hook 814 and the back wall 812.

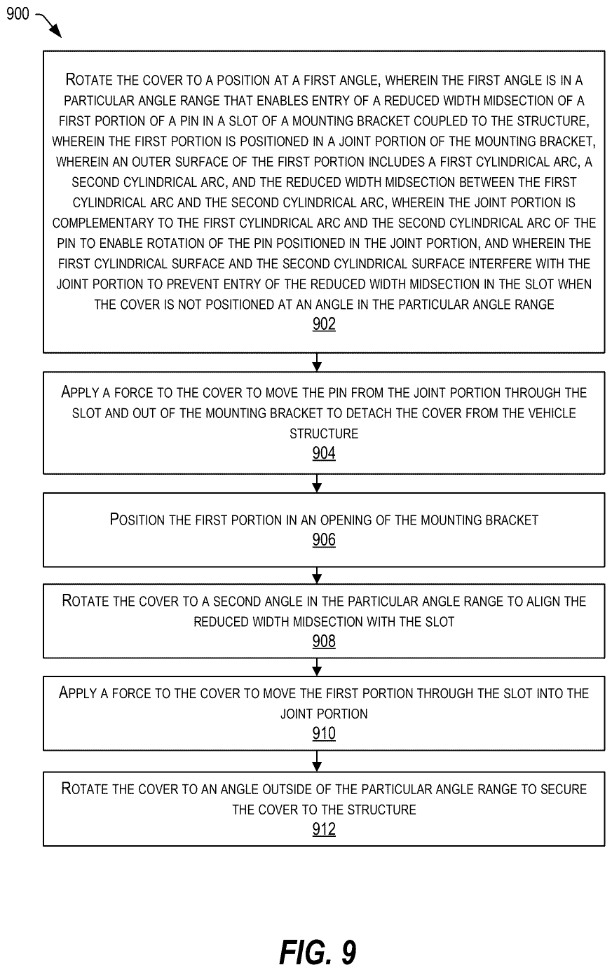

FIG. 9 is a flow chart of a method 900 of use of a lockout hanger system. The method 900 is performable using any of the lockout hanger systems 108 of FIGS. 1-8. The method 900 includes, at block 902, rotating the cover to a position at a first angle. The first angle is in a particular angle range that enables entry of a reduced width midsection of a first portion of a pin in a slot of a mounting bracket coupled to the structure. The first portion is positioned in a joint portion of the mounting bracket. An outer surface of the first portion includes a first cylindrical arc, a second cylindrical arc, and the reduced width midsection between the first cylindrical arc and the second cylindrical arc. The joint portion is complementary to the first cylindrical arc and the second cylindrical arc of the pin to enable rotation of the pin positioned in the joint portion. Also, the first cylindrical surface and the second cylindrical surface interfere with the joint portion to prevent entry of the reduced width midsection in the slot when the cover is not positioned at an angle in the particular angle range.

For example, a user may rotate a cover 114 from a closed position (0 degrees) to approximately 30 degrees relative to the structure. This 30-degree angle falls within a specific angle range (e.g., 28-32 degrees) where the reduced width midsection 214 of the pin 200 aligns with the slot 508 in the mounting bracket 506. At angles less than 28 degrees or greater than 32 degrees, the cylindrical arcs 220 of the pin 200 interfere with the joint portion 510 of the mounting bracket 506, preventing accidental disengagement.

The method 900 includes, at block 904, applying a force to the cover to move the pin from the joint portion through the slot and out of the mounting bracket to detach the cover from the vehicle structure. For example, once the cover 114 is rotated to the correct angle (e.g., 30 degrees), the user applies an upward force to the cover 114. This force causes the reduced width midsection 214 of the pin 200 to enter the slot 508 in the mounting bracket 506. As the user continues to apply the upward force, the pin 200 moves through the slot 508 and out of the mounting bracket 506, allowing the cover 114 to be completely removed from the structure.

In addition to using the lockout hanger system to separate a cover rotatably coupled to a structure from the structure, the lockout hanger system allows the cover that is separated from the structure to be rotatably attached to the cover. The method 900 includes, at block 906, positioning the first portion in an opening of the mounting bracket. For example, the user positions the pin 200 near or in the opening between the back surface of the mounting bracket 506 and an end of a hook of the mounting bracket at an end of the slot 508 of the mounting bracket 506 away from the joint portion 510 of the mounting bracket 506.

The method 900 includes, at block 908, rotating the cover to a second angle in the particular angle range to align the reduced width midsection with the slot. For example, the user rotates the cover 114 to approximately 30 degrees relative to the structure. This rotation aligns the reduced width midsection 214 of the pin 200 with the slot 508 in the mounting bracket 506. The user may refer to visual indicators or feel a slight change in resistance when the correct angle is reached.

The method 900 includes, at block 910, applying a force to the cover to move the first portion through the slot into the joint portion. For example, once the cover 114 is rotated to the correct angle (e.g., 30 degrees), gravity and/or a user applied force is applied to the cover 114. This force causes the reduced width midsection 214 of the pin 200 to enter the slot 508 in the mounting bracket 506. As application of the downward force continues, the pin 200 moves through the slot 508 and into the joint portion 510 of the mounting bracket 506.

The method 900 includes, at block 912, rotating the cover to an angle outside of the particular angle range to secure the cover to the structure. For example, after the pin 200 is fully seated in the joint portion 510, the user rotates the cover 114 back towards its closed position (e.g., from 30 degrees to 0 degrees). This rotation causes the cylindrical arcs 220 of the pin 200 to engage with the joint portion 510 of the mounting bracket 506. As the cover 114 moves out of the particular angle range (e.g., below 28 degrees), the interference between the cylindrical arcs 220 and the joint portion 510 prevents the pin 200 from re-entering the slot 508, thereby securely locking the cover 114 to the structure.

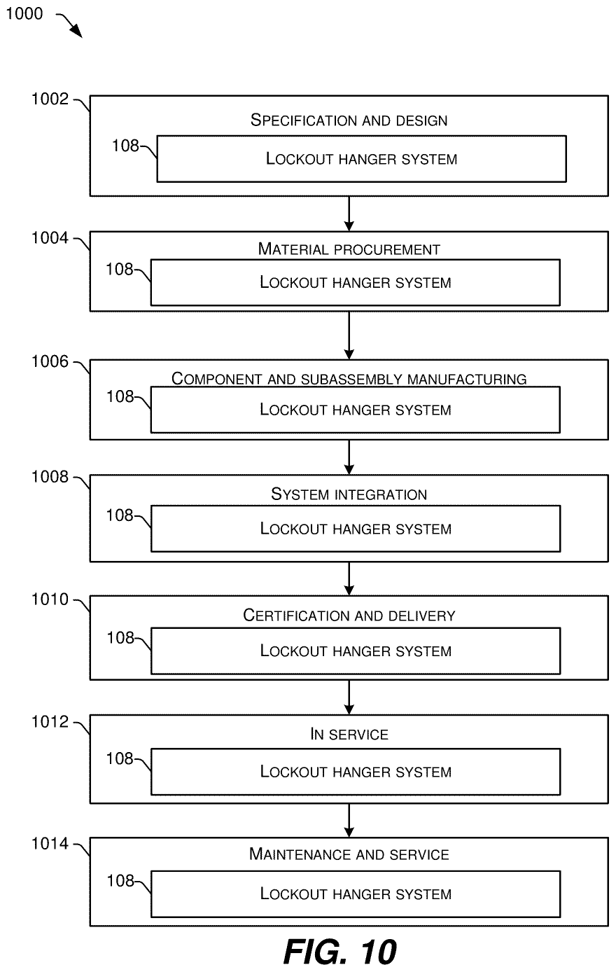

FIG. 10 is a flowchart illustrating an example 1000 of a life cycle of an aircraft that includes the lockout hanger system 108 of FIGS. 1-9. During pre-production, the exemplary method 1000 includes, at block 1002, specification and design of the aircraft. During specification and design of the aircraft, the method 1000 may include specification and design of the lockout hanger system 108 and locations where lockout hanger system 108 are to be placed. At block 1004, the method 1000 includes material procurement, which may include procuring materials for the lockout hanger system 108 or procuring pre-assembled lockout hanger systems 108.

During production, the method 1000 includes, at block 1006, component and subassembly manufacturing and, at block 1008, system integration of the aircraft. For example, the method 1000 may include component and subassembly manufacturing of the lockout hanger system 108, system integration of the lockout hanger system 108 with the aircraft, or both. At block 1010, the method 1000 includes certification and delivery of the aircraft and, at block 1012, placing the aircraft in service. Certification and delivery may include certification of the lockout hanger system 108 to place the lockout hanger system 108 in service. While in service by a customer, the aircraft may be scheduled for routine maintenance and service (which may also include modification, reconfiguration, refurbishment, and so on). At block 1014, the method 1000 includes performing maintenance and service on the aircraft, which may include performing maintenance and service on the lockout hanger system 108. For example, the maintenance and service can include replacing the pin 200, 512.

Each of the processes of the method 1000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

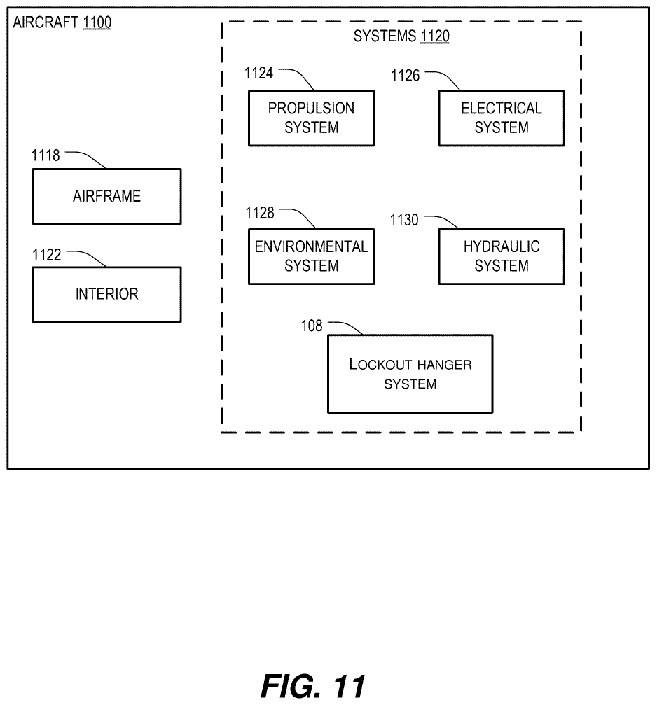

Aspects of the disclosure can be described in the context of an example of an aircraft 1100 as shown in FIG. 11. In the example of FIG. 11, the aircraft 1100 includes an airframe 1118 with a plurality of systems 1120 and an interior 1122 Examples of the plurality of systems 1120 include one or more of a propulsion system 1124, an electrical system 1126, an environmental system 1128, a hydraulic system 1130, and the lockout hanger system 108. Any number of other systems may be included. In the example of FIG. 10, the aircraft 1100 includes the lockout hanger system 108 in accordance with one or more aspects of the disclosure as described in FIGS. 1-8. Portions of the lockout hanger system 108 are included in the airframe 1118 and the interior 1122.

Particular aspects of the disclosure are described below in sets of interrelated Examples:

According to Example 1, a system includes a hinge-arm comprising a clevis end; a pin non-rotatably coupled to a first arm of the clevis end, wherein the pin includes a first portion between the first arm and a second arm of the clevis end, wherein an outer surface of the first portion includes a first cylindrical arc, a second cylindrical arc, and a reduced width midsection between the first cylindrical arc and the second cylindrical arc; and a mounting bracket configured to couple to a device, the mounting bracket configured to receive the pin to enable a cover coupled to the hinge-arm to be rotatable positioned relative to the device, wherein the mounting bracket comprises a slot to allow passage of the reduced width midsection of the pin and a joint portion complementary to the first cylindrical arc and the second cylindrical arc of the pin to enable rotation of the pin positioned in the joint portion relative to the mounting bracket, wherein the pin is removable from the joint portion when the hinge-arm is rotated relative to the mounting bracket to a particular angle range that enables entry of the reduced width midsection in the slot, and wherein the pin is retained in the joint portion at angles less than the particular angle range, greater than the particular angle range, or both, by interference of the first portion with the joint portion to prevent entry of the first portion in the slot.

Example 2 includes the system of Example 1, wherein the particular angle range includes an angle selected from the group consisting of 30 degrees, 35 degrees, 40 degrees, and 45 degrees relative to a closed position of the cover.

Example 3 includes the system of Example 1 or Example 2, wherein the hinge-arm is a gooseneck hinge-arm.

Example 4 includes the system of any of Examples 1 to 3, wherein the slot is shaped to allow passage of the reduced width midsection of the pin only when the hinge-arm is rotated to the particular angle range.

Example 5 includes the system of any of Examples 1 to 4 and further includes a pin lock out plate fastened to the first arm, wherein a head of the pin is positioned in a corresponding opening of the pin lock out plate to prevent rotation of the pin relative to the first arm.

Example 6 includes the system of Example 5, wherein the pin lock out plate is fastened to the first arm using screws, bolts, welds, or combinations thereof.

Example 7 includes the system of any of Examples 1 to 6 and further includes a bolt configured to extend through an opening of the pin.

Example 8 includes the system of Example 7 and further includes a cotter pin and a nut configured to secure the pin to the hinge-arm, wherein the nut is threaded onto the bolt, and wherein a first portion of the cotter pin is configured to be positioned in an opening through the bolt, and second portions of the cotter pin are configured to be positioned in recesses of the nut.

Example 9 includes the system of any of Examples 1 to 8 and further includes a first flange and a second flange, wherein the first flange is secured between the first arm and the second arm of the clevis end, and the second flange extends beyond the clevis end of the hinge-arm.

Example 10 includes the system of any of Examples 1 to 9, wherein the reduced width midsection of the pin has a non-circular cross-section.

According to Example 11, a system includes a hinge-arm having a clevis end with a first arm and a second arm; a pin non-rotatably coupled to the first arm of the clevis end, wherein the pin includes a first portion between the first arm and the second arm of the clevis end, wherein an outer surface of the first portion includes a first cylindrical arc, a second cylindrical arc, and a reduced width midsection between the first cylindrical arc and the second cylindrical arc; a mounting bracket configured for attachment to a structure, the mounting bracket including: a joint portion having a diameter complementary to the first cylindrical arc and the second cylindrical arc of the pin to enable rotation of the pin positioned in the joint portion relative to the mounting bracket; and a slot extending from the joint portion, the slot sized to allow passage of the reduced width midsection of the pin; wherein the pin is removable from the joint portion when the hinge-arm is rotated relative to the mounting bracket to a particular angle range that enables entry of the reduced width midsection in the slot; and wherein the pin is retained in the joint portion at angles less than the particular angle range, greater than the particular angle range, or both, by interference of the first portion with the joint portion to prevent entry of the first portion in the slot.

Example 12 includes the system of Example 11, wherein the particular angle range includes an angle between 35 and 45 degrees relative to a closed position of the hinge-arm.

Example 13 includes the system of Example 11 or Example 12, further comprising a cover coupled to the hinge-arm, wherein the cover is configured to be secured in a closed position relative to the structure when the pin is retained in the joint portion.

Example 14 includes the system of any of Examples 11 to 13 and further includes a pin lock out plate fastened to the first arm, wherein a head of the pin is positioned in a corresponding opening of the pin lock out plate to prevent rotation of the pin relative to the first arm.

Example 15 includes the system of any of Examples 11 to 14 and further includes one or more fasteners configured to couple a lock out plate to the first arm.

Example 16 includes the system of any of Examples 11 to 15, wherein the slot in the mounting bracket is shaped to guide the first portion of the pin during insertion and removal of the pin from the slot.

Example 17 includes the system of any of Examples 11 to 16, wherein the hinge-arm is a gooseneck hinge-arm.

Example 18 includes the system of any of Examples 11 to 17 and further includes a bolt configured to extend through an opening of the pin.

According to Example 19, a method for removing a cover from a structure, the method comprising: rotating the cover to a position at a first angle, wherein the first angle is in a particular angle range that enables entry of a reduced width midsection of a first portion of a pin in a slot of a mounting bracket coupled to the structure, wherein the first portion is positioned in a joint portion of the mounting bracket, wherein an outer surface of the first portion includes a first cylindrical arc, a second cylindrical arc, and the reduced width midsection between the first cylindrical arc and the second cylindrical arc, wherein the joint portion is complementary to the first cylindrical arc and the second cylindrical arc of the pin to enable rotation of the pin positioned in the joint portion, and wherein the first cylindrical surface and the second cylindrical surface interfere with the joint portion to prevent entry of the reduced width midsection in the slot when the cover is not positioned at an angle in the particular angle range; and applying a force to the cover to move the pin from the joint portion through the slot and out of the mounting bracket to detach the cover from the structure.

Example 20 includes the method of Example 19, further includes positioning the first portion in an opening of the mounting bracket; rotating the cover to a second angle in the particular angle range to align the reduced width midsection with the slot; apply a force to the cover to move the first portion through the slot into the joint portion; and rotating the cover to an angle outside of the particular angle range to secure the cover to the structure.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A system comprising:
a hinge-arm comprising a clevis end;
a pin non-rotatably coupled to a first arm of the clevis end, wherein the pin includes a first portion between the first arm and a second arm of the clevis end, wherein an outer surface of the first portion includes a first cylindrical arc, a second cylindrical arc, and a reduced width midsection between the first cylindrical arc and the second cylindrical arc; and
a mounting bracket configured to couple to a device, the mounting bracket configured to receive the pin to enable a cover coupled to the hinge-arm to be rotatable positioned relative to the device, wherein the mounting bracket comprises a slot to allow passage of the reduced width midsection of the pin and a joint portion complementary to the first cylindrical arc and the second cylindrical arc of the pin to enable rotation of the pin positioned in the joint portion relative to the mounting bracket, wherein the pin is removable from the joint portion when the hinge-arm is rotated relative to the mounting bracket to a particular angle range that enables entry of the reduced width midsection in the slot, and wherein the pin is retained in the joint portion at angles less than the particular angle range, greater than the particular angle range, or both, by interference of the first portion with the joint portion to prevent entry of the first portion in the slot.

2. The system of claim 1, wherein the particular angle range includes an angle selected from the group consisting of 30 degrees, 35 degrees, 40 degrees, and 45 degrees relative to a closed position of the cover.

3. The system of claim 1, wherein the hinge-arm is a gooseneck hinge-arm.

4. The system of claim 1, wherein the slot is shaped to allow passage of the reduced width midsection of the pin only when the hinge-arm is rotated to the particular angle range.

5. The system of claim 1, further comprising a pin lock out plate fastened to the first arm, wherein a head of the pin is positioned in a corresponding opening of the pin lock out plate to prevent rotation of the pin relative to the first arm.

6. The system of claim 5, wherein the pin lock out plate is fastened to the first arm using screws, bolts, welds, or combinations thereof.

7. The system of claim 1, further comprising a bolt configured to extend through an opening of the pin.

8. The system of claim 7, further comprising a cotter pin and a nut configured to secure the pin to the hinge-arm, wherein the nut is threaded onto the bolt, and wherein a first portion of the cotter pin is configured to be positioned in an opening through the bolt, and second portions of the cotter pin are configured to be positioned in recesses of the nut.

9. The system of claim 1, further comprising a first flange and a second flange, wherein the first flange is secured between the first arm and the second arm of the clevis end, and the second flange extends beyond the clevis end of the hinge-arm.

10. The system of claim 1, wherein the reduced width midsection of the pin has a non-circular cross-section.

11. A system comprising:
a hinge-arm having a clevis end with a first arm and a second arm;
a pin non-rotatably coupled to the first arm of the clevis end, wherein the pin includes a first portion between the first arm and the second arm of the clevis end, wherein an outer surface of the first portion includes a first cylindrical arc, a second cylindrical arc, and a reduced width midsection between the first cylindrical arc and the second cylindrical arc;
a mounting bracket configured for attachment to a structure, the mounting bracket including:
a joint portion having a diameter complementary to the first cylindrical arc and the second cylindrical arc of the pin to enable rotation of the pin positioned in the joint portion relative to the mounting bracket; and
a slot extending from the joint portion, the slot sized to allow passage of the reduced width midsection of the pin;
wherein the pin is removable from the joint portion when the hinge-arm is rotated relative to the mounting bracket to a particular angle range that enables entry of the reduced width midsection in the slot; and
wherein the pin is retained in the joint portion at angles less than the particular angle range, greater than the particular angle range, or both, by interference of the first portion with the joint portion to prevent entry of the first portion in the slot.

12. The system of claim 11, wherein the particular angle range includes an angle between 35 and 45 degrees relative to a closed position of the hinge-arm.

13. The system of claim 11, further comprising a cover coupled to the hinge-arm, wherein the cover is configured to be secured in a closed position relative to the structure when the pin is retained in the joint portion.

14. The system of claim 11, further comprising a pin lock out plate fastened to the first arm, wherein a head of the pin is positioned in a corresponding opening of the pin lock out plate to prevent rotation of the pin relative to the first arm.

15. The system of claim 11, further comprising one or more fasteners configured to couple a lock out plate to the first arm.

16. The system of claim 11, wherein the slot in the mounting bracket is shaped to guide the first portion of the pin during insertion and removal of the pin from the slot.

17. The system of claim 11, wherein the hinge-arm is a gooseneck hinge-arm.

18. The system of claim 11, further comprising a bolt configured to extend through an opening of the pin.

19. A method for removing a cover from a structure, the method comprising:
rotating the cover to a position at a first angle, wherein the first angle is in a particular angle range that enables entry of a reduced width midsection of a first portion of a pin in a slot of a mounting bracket coupled to the structure, wherein the first portion is positioned in a joint portion of the mounting bracket, wherein an outer surface of the first portion includes a first cylindrical arc, a second cylindrical arc, and the reduced width midsection between the first cylindrical arc and the second cylindrical arc, wherein the joint portion is complementary to the first cylindrical arc and the second cylindrical arc of the pin to enable rotation of the pin positioned in the joint portion, and wherein the first cylindrical surface and the second cylindrical surface interfere with the joint portion to prevent entry of the reduced width midsection in the slot when the cover is not positioned at an angle in the particular angle range; and
applying a force to the cover to move the pin from the joint portion through the slot and out of the mounting bracket to detach the cover from the structure.

20. The method of claim 19, further comprising:
positioning the first portion in an opening of the mounting bracket;
rotating the cover to a second angle in the particular angle range to align the reduced width midsection with the slot;
applying a force to the cover to move the first portion through the slot into the joint portion; and
rotating the cover to an angle outside of the particular angle range to secure the cover to the structure.
